(19) United States
(12) Patent Application Publication
(10) Pub. No.: US 2014/0071269 A1
(43) Pub. Date: Mar. 13, 2014

(54) Reference Measurement System for Rail Applications

(71) Applicant: HARSCO CORPORATION, Camp Hill, PA (US)

(72) Inventors: Omar MOHAMED, Munich (DE); Peter MAURICE, Irmo, SC (US)

(73) Assignee: HARSCO CORPORATION, Camp Hill, PA (US)

(21) Appl. No.: 14/019,640

(22) Filed: Sep. 6, 2013

Related U.S. Application Data
(60) Provisional application No. 61/698,373, filed on Sep. 7, 2012.

(51) Int. Cl. G01B 11/14; B61K 13/00

(52) U.S. Cl. CPC G01B 11/14; B61K 13/00
USPC 348/135

(57) ABSTRACT

A reference measurement system includes a rail vehicle configured to move along rails of a track. An imaging system is disposed on the rail vehicle and is configured to capture one or more images of a reference point. The system further includes a processor, which is configured to calculate a relative position between the rails and the reference point based on the image. Related methods for making reference measurements are described.

### CROSS-REFERENCE TO RELATED APPLICATION

This application claims priority to U.S. Provisional Patent Application No. 61/698,373 filed on Sep. 7, 2012, the disclosure of which is hereby incorporated by reference in its entirety.

### BACKGROUND

For many track maintenance actions it is necessary to measure track geometry. In case of a high speed line on which trains travel at a high speed (for example over 200 kph), an acceptable wavelength for track deviations can be quite high. For example, to damp oscillations and limit suspension movement at a frequency of 1 Hz, a distance of a wavelength from a peak through a valley to a next peak may be 200 m or greater.

In some cases, such as for tamping activities, it is also necessary to calculate a correction to the track geometry. During tamping activities the track position is changed in the area of only some millimeters up to several centimeters. Thus, very precise measurements over long distances may be needed.

For some of these corrections (tamping to an absolute track position and not only smoothing of the track geometry) additional measurements are carried out to acquire the absolute position of the track relative to track-side reference points considered to be fixed in space. Such reference points are often mounted on catenary masts, other fixed objects, survey markers, etc.

Systems for the measurement of relative position of the track, such as laser chords, track geometry measurement systems with inertial packs and three point measurement systems, are available. These measurement systems all have in common that they measure track geometry relative to previous measurement points. To measure absolute position of the track at discrete locations, manual or semi-manual measurement of the position of the track relative to reference points by hand laser tools and D-GPS are available. However, measurements using these methods are time-intensive (hand laser tools) and relatively inaccurate (D-GPS—when used for measurements under a normally used period of time).

Measurements carried out with laser measurement systems to acquire the position of the track relative to the track-side reference points are commonly used for tamping operations. However, these laser measurement systems require a first operator team in front of the vehicle to place measurement equipment on the track rails to measure the position of the track. A second operator team is required behind the vehicle to place measurement equipment on the track rails after the vehicle has performed work to verify the adjusted position of the track. The presence of the operator team working on the track also leads to safety personnel being required to secure the work of the measurement team. In sum, 2-6 persons per tamping shift may be required to perform these measurements. Thus, laser measurement systems are slow and labor intensive. Further, laser measurement generally requires some kind of operator interaction to carry out.

To obtain accurate measurements carried out with a D-GPS system, the system must remain stationary for an extended period of time, sometimes many hours, to obtain enough data to average to determine an accurate absolute location suitable for tamping operations. Such an approach is not practical. Performing multiple passes over a track, even as many as four passes, provides position measurement accurate only on the scale of several centimeters, which is insufficient for many track operations.

### BRIEF SUMMARY

The present disclosure relates to a reference measurement system for rail applications. In one embodiment, the reference measurement system may be included on rail maintenance equipment such as a tamping vehicle configured for tamping ballast to change track position or an anchor adjustor vehicle configured for operation along the length of rail. It will be appreciated that the described rail maintenance equipment is exemplary in nature and the described systems and methods may be adapted for any vehicle.

One aspect of the present disclosure is the ability to determine the position of the track relative to reference points using an imaging system. The imaging system may measure distance to the reference point, elevation to the reference point, tilt angle to the reference point or any combination thereof. In one embodiment of the present disclosure, a track measurement system includes a rail vehicle configured to move along rails, at least one imaging system mounted on the rail vehicle and configured to capture at least one image of a reference point, and a processor configured to calculate a relative position between the rails and the reference point based on the at least one image. Related methods are also described.

### BRIEF DESCRIPTION OF THE DRAWINGS

Reference is now made to the following descriptions taken in conjunction with the accompanying drawings.

FIG. 1 illustrates a reference point relative to a rail track;

FIG. 2 illustrates a detailed view of the reference point of FIG. 1;

FIG. 3 illustrates an imaging system for reference point measurement according to one embodiment of the present disclosure;

FIGS. 4A and 4B illustrate a measurement relative to a reference point;

FIG. 5 illustrates a data processing system for carrying out measurements according to the present disclosure; and

FIG. 6A illustrates a perspective view of an imaging system;

FIG. 6B illustrates an exemplary image taken by the imaging system of FIG. 6A; and

FIGS. 7A, 7B, 7C, 8A, 8B, 8C and 8D illustrate sample horizontal and vertical distance calculations to a reference point.

### DETAILED DESCRIPTION

Various embodiments of a reference measurement system for rail applications and methods of making such measurements according to the present disclosure are described. It is to be understood, however, that the following explanation is merely exemplary in describing the devices and methods of the present disclosure. Accordingly, several modifications, changes and substitutions are contemplated.

An aspect of the present disclosure is to automate reference measurements by utilizing different measurement methods and combining them to acquire the track position in relation to track-side reference points. Such measurements can be carried out from moving vehicles and may be performed with no operator interaction. The relative position of the track may be compared to track-side reference points. Thus, the absolute position of the track may be determined if the reference points are absolutely positioned in space.

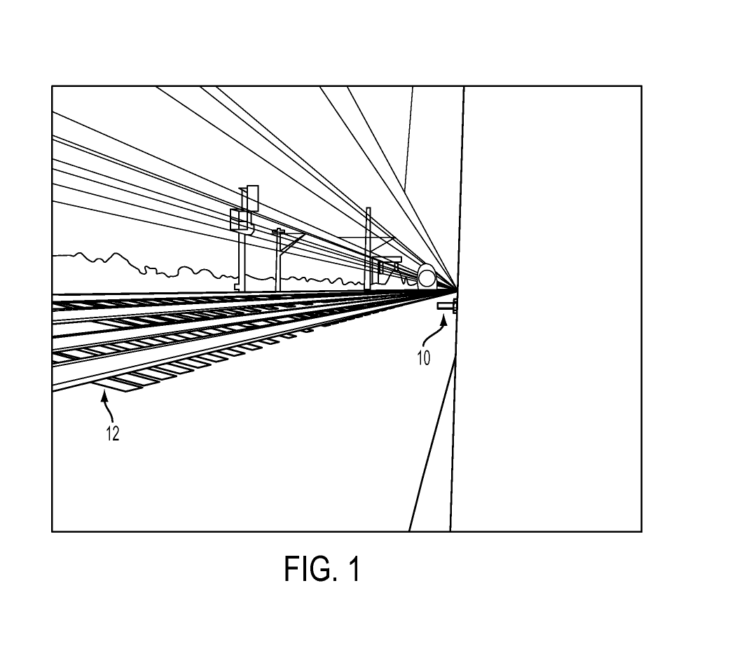

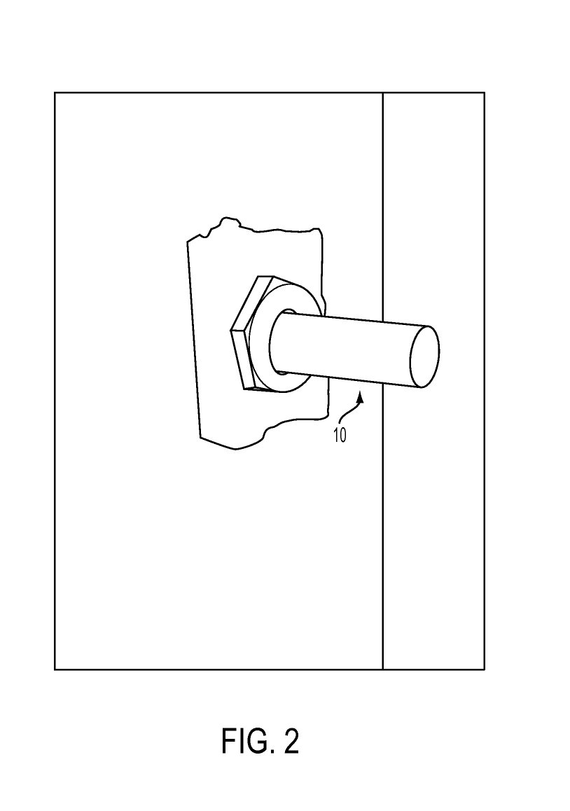

FIGS. 1 and 2 show an example of a track-side reference point 10 disposed adjacent to a track 12. The track-side reference point 10 may be installed at a wide variety of distances from the track 12. Typical distances may be anywhere between 2-5 meters. It will be appreciated that reference points may be located in various positions depending on the specific application.

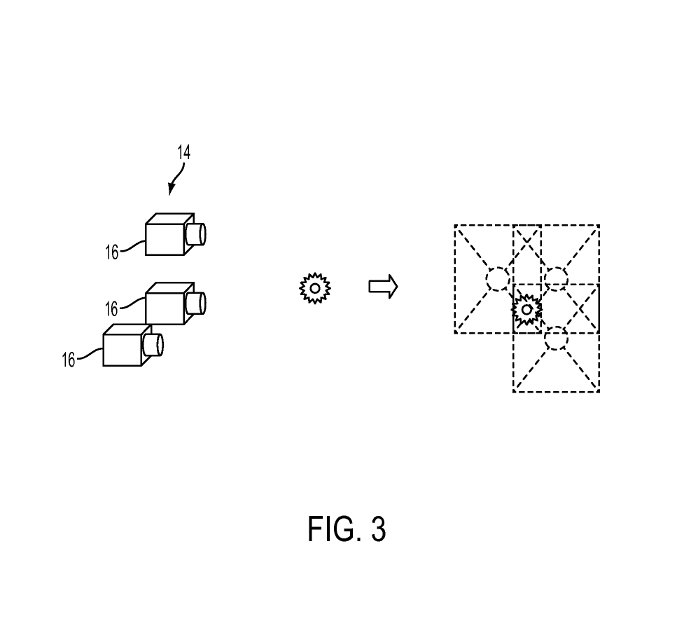

In one embodiment, and with reference to FIG. 3, a reference measurement system 14 may include two or more high-resolution cameras 16 providing multiple perspectives of a single point-shaped object for measuring the position of the single point-shaped object placed at the track-side reference point. The number of perspectives (and thereby the number of high-resolution cameras) may be selected based on accuracy requirements.

The position of the cameras 16 (distance and elevation/tilt angle), which are set at fixed distances from each other, relative to the reference point can be calculated, for example by a general or special purpose processor, based on the two (or more) perspectives provided by the images of the single point-shaped object by matching objects in images from the cameras. In some embodiments, three or more cameras may be used to find the relative distance in a three dimensional space.

The position of the cameras 16 relative to a track geometry measurement system (laser chord, inertial system, three point system, etc.) can generally be determined as they can be mounted in a fixed relation to each other on a track vehicle. However, in some embodiments, the cameras 16 may be movable relative to the track vehicle in a predetermined manner.

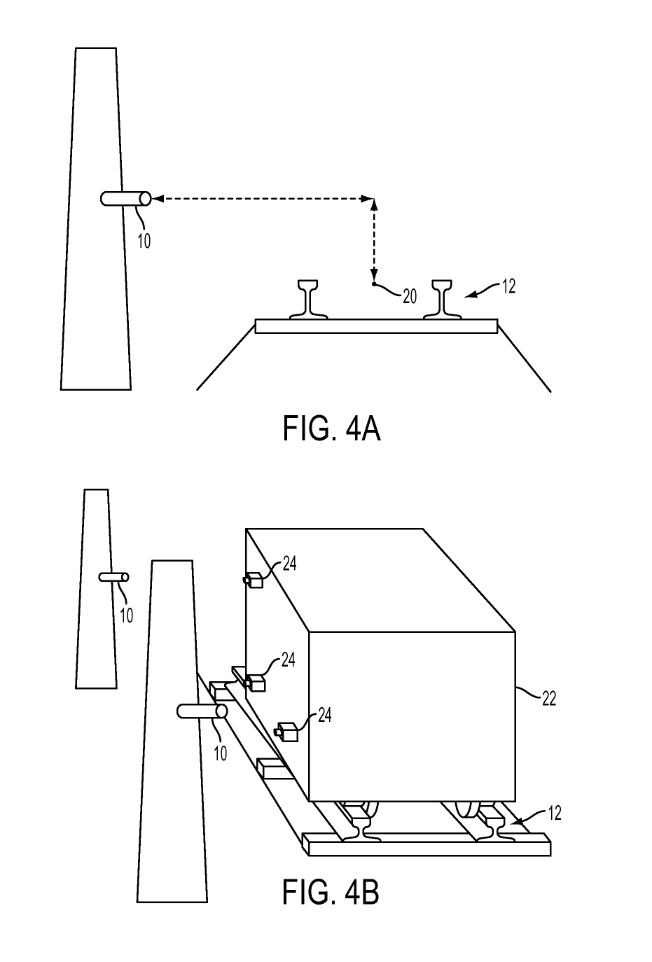

A track geometry measurement system may utilize a camera/laser system to measure the position of the track relative to the reference measurement system 14. Thus—combining the measurement of track geometry, the knowledge of the position of the cameras 16 relative to the track geometry system and the position of the track-side reference point 10 relative to the cameras—the track geometry can be measured in relation to the single point-shaped object 10 placed at the track-side reference point as shown in FIG. 4. With a reference point that is fixed in space, the position of the track may be measured absolutely and is no longer relative to previous measurement points. In the case of FIG. 4A, a specified position 20 between the rails, which may be at the level of the lower of the two rails (i.e., level with the upper portion of the lower of the two rails), and the reference point is measured. This parameter is often specified in the construction and positioning of the rails as well as data used to verify and qualify tamping success after tamping work has been performed.

In another embodiment, one or more cameras 16 obtain images of the reference point 10 at different points of time to provide different perspectives while the reference measurement system 14 moves along the track. The relative position of the cameras 16 between the images may be determined based on inertial measurements or calculated based from the traveling speed and known features of the track geometry. Thus, images having multiple perspectives of the reference point 10 are obtained and a relative distance between the reference measurement system and the reference point can be determined.

In still another embodiment, one or more cameras 16 may be configured to change position relative to the reference measurement system 14 to obtain images having multiple perspectives of the reference point 10. The one or more cameras 16 may change position by shifting the camera to a new position.

In yet another embodiment, a single camera 16 may obtain a composite image having multiple perspectives of the reference point at one time. For example, an optical system may use a system of lenses and mirrors to obtain multiple views of the reference point 10 in a single image.

It is to be appreciated that although an exemplary embodiment has been described in the context of camera systems, the principles of the present disclosure are applicable to other imaging systems. For example, a single point monochrome light source such as a monochrome LED may be used at the reference point 10 with matching filters on the camera for increased performance and filtering out of stray light. As another example, a monochrome light source may be mounted at the vehicle with the cameras, reflecting off a point-shaped reflector at the reference point removing the need for a powered light source at the track-side reference point 10.

With reference to FIG. 4B, it will be appreciated that an imaging system 24 (e.g., one or more cameras) may be placed on any railway vehicle 22 to measure the position of the cameras relative to the reference point 10. The reference points may be placed some distance, for example 50 m, apart. Between the reference points, the reference measurement system may use an inertial pack to measure relative change in position and relative track geometry—to approximate the absolute position of the track also between the reference points. The known relationship of the camera system to the track geometry, which may be constant or may vary based on a known relationship, allows for the determination of track location relative to the reference point based on the measurement of the relative location of the camera system to the reference point and the known relationship between the location of the camera system and the tracks.

It will also be appreciated that the reference measurement system 14 may be augmented with additional sensors, such as D-GPS or an equivalent, to obtain the positioning of the reference points in 3D-space to measure the absolute position of the track.

The reference measurement system 14 may also include a time-of-flight measurement system that includes multiple radio frequency receivers to determine the relative position of the reference point. In such an embodiment, the cameras of FIG. 4B may be replaced with radio frequency receivers and the reference points may include a transmitter or be adapted to reflect a signal transmitted by the reference measurement system in order to calculate time-of-flight and triangulate the distance to the reference points. The reference point, the reference measurement system, or both, may use direction antennas for transmitting and/or receiving the radio signal.

In some embodiments, the described processes and calculations may be executed by a special purpose processor/computer or a general purpose processor programmed to execute the process. For example, the correction process may also be in the form of computer executable instructions that, when executed by a processor, cause the processor to execute the correction process. The computer executable instructions may be stored on one or more computer readable mediums (e.g., RAM, ROM, etc) in whole or in parts.

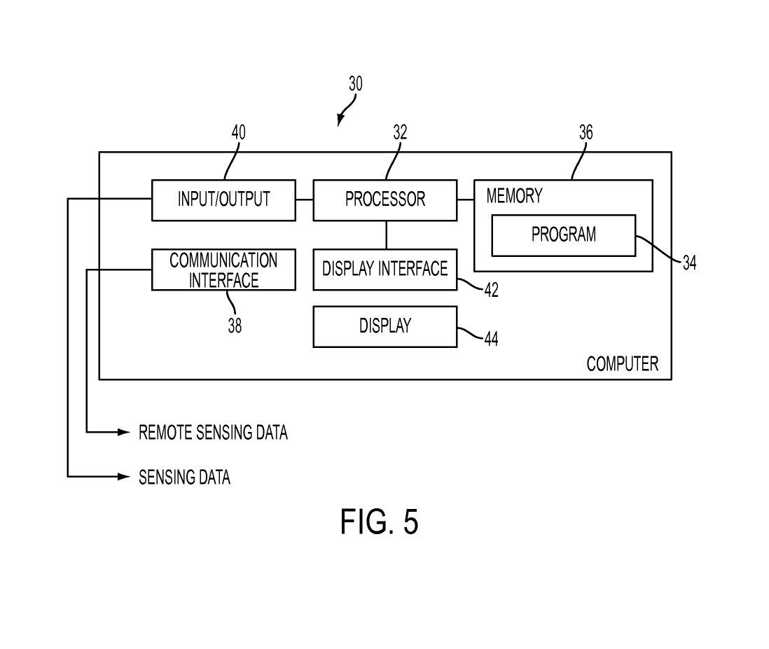

For example, referring to FIG. 5, some embodiments of a computer or data processing system 30 may include a processor 32 configured to execute at least one program 34 stored in a memory 36 for the purposes of processing data to perform one or more of the techniques that are described herein. The processor 32 may be coupled to a communication interface 38 to receive remote sensing data. The processor 32 may also receive the sensing data via an input/output block 40. In addition to storing instructions for the program, the memory 36 may store preliminary, intermediate and final datasets involved in the techniques that are described herein. Among its other features, the computer or data processing system 30 may include a display interface 42 and a display 44 that displays the various data that is generated as described herein. It will be appreciated that the computer or data processing system 30 shown in FIG. 5 is merely exemplary (for example, the display may be separate from the computer, etc) in nature and is not limiting of the systems and methods described herein.

Sample Horizontal Distance Calculation to Reference Point

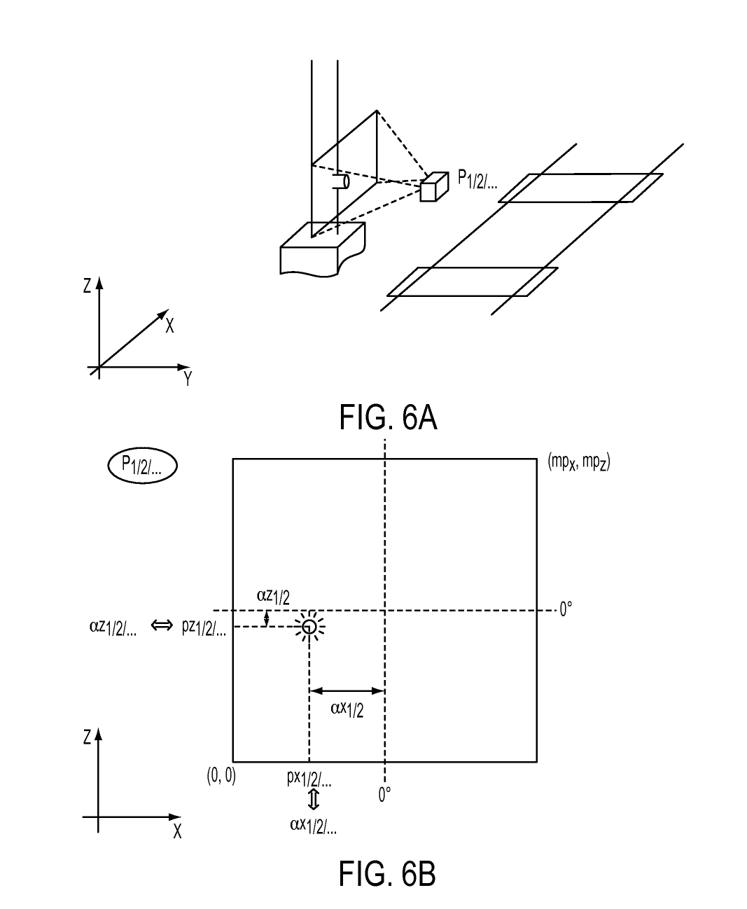

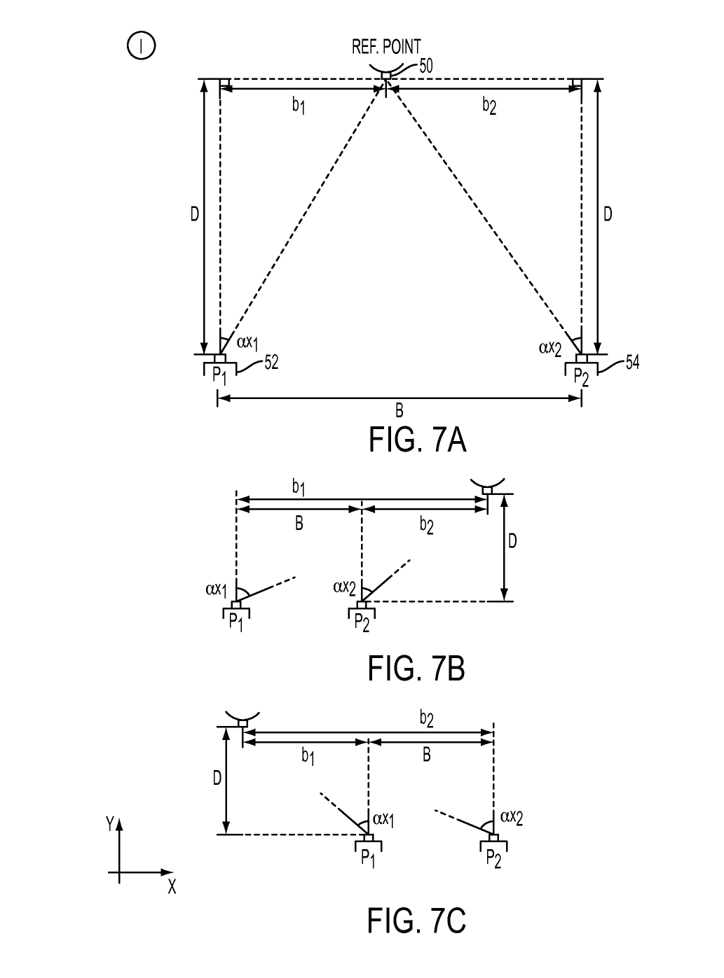

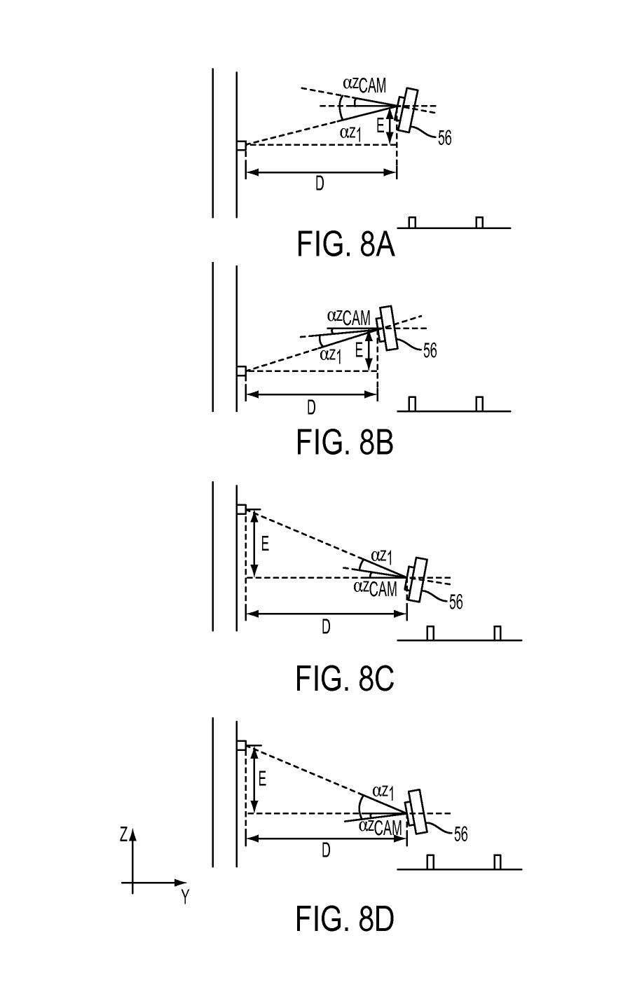

Referring to FIGS. 6A-B and 7A-C, the distance D to a reference point 50 may be calculated using two or more perspectives. Cameras 52, 54 (FIG. 7) of the imaging system shown in FIG. 6A may be calibrated and image distortions (originating from lenses etc.) may be compensated in the transformation:

px_{1,2} [symbol] ax_{1,2} pz_{1,2} [symbol] az_{1,2}

In a camera image of the target where the camera is pointing at right angles to the track, the horizontal distance of the target from the center of the image gives the angle of a line through the focal point of the lens and the axis of the camera. The angle calculation, based on image information, is performed so that any angle towards the second perspective or image is positive and any angle away from the second perspective or image is negative.

The camera/lens setup limitations give that:

−90°<ax_{1,2}<+90°

−90°<az_{1,2}<+90°

In the cases that follow, the following parameters are known:

ax_{1,2} B

Case I

The following are known from the geometry shown in FIG. 7A:

$$α {x}_{1} > 0 \qquad {b}_{1} > 0 \qquad α {x}_{2} > 0 \qquad {b}_{2} > 0$$

$$tan ( α {x}_{1} ) = \frac{{b}_{1}}{D} \qquad tan ( α {x}_{2} ) = \frac{{b}_{2}}{D}$$

$$B = {b}_{1} + {b}_{2} = D \cdot ( tan ( α {x}_{1} ) + tan ( α {x}_{2} ) )$$

Thus, the distance D can be calculated as shown in the following equation:

$$D = \frac{B}{tan ( α {x}_{1} ) + tan ( α {x}_{2} )}$$

Cases II and III

Variations of the geometry shown in FIG. 7A are shown in FIGS. 7B and 7C. In FIG. 7B, the angle ax₂ is reversed in polarity relative to FIG. 7A. In FIG. 7C, the angle ax₁ is reversed in polarity relative to FIG. 7A. Thus, the same equations described with respect to Case I apply to Cases II and III provided the angle polarities are applied as described.

Sample Vertical Distance Calculation to Reference Point

The following discussion refers to the examples shown in FIGS. 6A-B and 8A-D. The height difference E to a reference point can be calculated using one or more perspectives.

Cameras, such as camera 56 in FIGS. 8A-D, may be calibrated and image distortions (originating from lenses etc.) may be compensated in the transformation:

px_{1,2} [symbol] ax_{1,2} pz_{1,2} [symbol] az_{1,2}

An additional measurement of the camera angle relative to the horizontal level is represented by az_{CAM}.

In a camera image of the target, the vertical distance of the target from the center of the image gives the angle of a line through the focal point of the lens and the axis of the camera. The angle calculation, based on image information, is performed so that any upward angle is positive and any downward angle is negative.

Furthermore any upward angle of the camera itself relative to the absolute horizontal is positive and any downward angle of the camera itself relative to the absolute horizontal is negative.

In the cases that follow, the following parameters are known:

az₁ D az_{CAM}

Case I

The following are known from the geometry shown in FIG. 8A:

az₁<0 az_{CAM}>0 abs(az_{CAM)<abs(az}₁)

Then, the height difference E can be calculated in the following equation:

E=D·tan(az₁+az_{CAM}) where E<0

Case II

The following are known from the geometry shown in FIG. 8B,

az₁<0 az_{CAM}<0

Then, the height difference E can be calculated:

E=D·tan(az₁+az_{CAM}) where E<0

Case III

The following are known from the geometry shown in FIG. 8C,

az₁>0 az_{CAM}>0

Then, the height difference E can be calculated:

E=D·tan(az₁+az_{CAM}) where E>0

Case IV

The following are known from the geometry shown in FIG. 8D,

az₁>0 az_{CAM}<0 abs(az_{CAM})<abs(az₁)

Then, the height difference E can be calculated:

E=D·tan(az₁+az_{CAM}) where E>0

Additional Cases

The following cases are not graphically depicted:

az₁>0 az_{CAM}<0 abs(az_{CAM})>abs(az₁)

az₁<0 az_{CAM}>0 abs(az_{CAM})>abs(az₁)

In both case, in a manner analogous to those of Cases I-IV, the height difference E can be calculated:

E=D·tan(az₁+az_{CAM})

Assuming the definition of angles and directions shown above, the following formula is valid for all cases:

E=D·tan(az₁+az_{CAM})

It will be appreciated that the above described mathematical models are exemplary in nature and other methods are also contemplated. For example, in another approach, calibration output (which may include compensation for image distortions) and the computation of the distance from the cameras to the target may be obtained as follows:
1. Calibration may be performed in a controlled environment, using a calibration screen at an intended reference point (such as a mast) location with individually illuminating points approximately 5 mm apart. A large display such as a flat screen monitor big enough to cover the possible range of targets may be used. In an alternative, multiple runs with a smaller screen may be used. With a camera pair mounted at a minimum distance from the calibration screen, the screen cycles through the array of target locations (5 mm apart in x and z directions). This may generate a large number of x1, z1, x2, z2 pairs per square meter of target area (for example, 40,000). The camera pair may then be moved back 5 mm and the process repeated until calibration for the required distance range y is acquired.

2. When using the calibration data to perform a distance to target measurement, the target image may first be used to acquire the x1, z1 and x2, z2 coordinate pairs. In an embodiment, the reference measurement system may compare (subtract) the measurement coordinates from each calibration pair. The closest pairs may be narrowed down to the nearest four pairs on two y planes. The resulting 8 pairs may be used to interpolate the final result (y distance from the target). Other algorithms, such as those that may reduce the number of comparisons needed, may also be used.

Tamping Operation

The above-described reference measurement system may be used in a tamping operation. However, this is merely an exemplary application. For example, the reference measurement system may also be used to simply act as a measuring system to verify whether a track has moved or to measure construction quality. It can also be used on any vehicle where a reference measurement is useful.

A tamping operation may be performed in three phases. In a first phase, the position of the track is measured and a needed repositioning of the track is calculated. In a second phase, the tamping operation is performed. In a third phase, the track position is verified. These phases are not necessarily distinct. For example, the verification of the third phase may be carried out while the tamping operation of the second phase is being performed.

In the first phase, the position for the track is measured. Measuring the track position may be performed in one or more runs down the track. For example, a first high speed run may be used followed by a low speed run. In the high speed run, inertial measurements are collected to determine relative changes in the track. Inertial measurements may require a minimum speed such as 15 kph+ to provide accurate data. In the low speed run, the imaging system is used to determine the location of the track relative to the reference points at regular intervals where the reference points are located. In combination, the data collected from the high speed run and the low speed run provide the position of the rails of the track with respect to the reference points throughout the work area. Needed repositioning of the track may then be calculated to form a repositioning plan and the tamping operation performed according to the calculated repositioning plan. A present location of the tamping machine during the tamping work may be determined through the use of counting sleepers/ties, an encoder mounted on a vehicle axle, GPS, other devices, or a combination thereof. The tamping work, implementing the changes as per the repositioning plan, may be carried out using a three point system.

In the third phase, the position of the tamped track is verified. The verification may be provided using inertial measurements and/or measurements from the image system. In some embodiments, the verification of the position of the tamped track may be performed during the tamping operation by mounting the relevant sensors of the reference measurement system or the camera system on a location of the track tamping machine that has a position with a known relationship to the finished track. Due to the vibration of the tamping activity, the inertial measurements may not be accurate enough to provide sufficient accuracy. Thus, the imaging system may be preferred.

Also, the imaging system may be configured to capture the images and perform the measurement when the tamping machine crosses a tie. That is, the tamping machine will generally lift the work heads out of the ballast when passing over a tie. During this interval, vibrations from the tamping operations are reduced and more accurate position of the track may be obtained.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

What is claimed is:

1. A reference measurement system for rail applications, comprising:
a rail vehicle configured to move along rails;
at least one imaging system mounted on the rail vehicle and configured to capture at least one image of a reference point; and
a processor configured to calculate a relative position between the rails and the reference point based on the at least one image.

2. A reference measurement system according to claim 1, wherein the relative position between the rails is substantially at a midpoint between the rails and at a level of the lower of the rails.

3. A reference measurement system according to claim 1, wherein the processor is configured to calculate a distance between the imaging system and the reference point based on the at least one image.

4. A reference measurement system according to claim 1, wherein the processor is configured to calculate an elevation between the imaging system and the reference point based on the at least one image.

5. A reference measurement system according to claim 1, wherein the processor is configured to calculate a tilt angle between the imaging system and the reference point based on the at least one image.

6. A reference measurement system according to claim 1, wherein the reference point is a point-shaped object fixed in space and disposed adjacent to the track.

7. A reference measurement system according to claim 1, wherein the at least one imaging system comprises two or more cameras positioned at fixed distances from one another.

8. A reference measurement system according to claim 7, wherein the two or more cameras capture two or more images of the reference point, the two or more images having objects common to the two or more images.

9. A reference measurement system according to claim 8, wherein the processor is configured to match the common objects in the two or more images to calculate a relative position between the rails and the reference point.

10. A reference measurement system according to claim 1, wherein the at least one imaging system comprises one or more cameras.

11. A reference measurement system according to claim 10, wherein the one or more cameras are configured to capture images of the reference point at different points in time.

12. A reference measurement system according to claim 10, wherein the one or more cameras are configured to change position relative to the rail vehicle to capture multiple perspectives of the reference point.

13. A reference measurement system according to claim 10, wherein the one or more cameras includes at least one camera configured to capture a composite image having multiple perspectives of the reference point at the same time.

14. A method for making a reference measurement in rail applications, comprising:
providing a rail vehicle configured to move along rails, the rail vehicle having at least one imaging system mounted thereon;
capturing at least one image of a reference point using the at least one imaging system; and
determining a relative position between the rails and the reference point based on the at least one image.

15. A method according to claim 14, wherein determining a relative position between the rails and the reference point comprises determining a distance between the imaging system and the reference point based on the at least one image.

16. A method according to claim 14, wherein determining a relative position between the rails and the reference point comprises determining an elevation between the imaging system and the reference point based on the at least one image.

17. A method according to claim 14, wherein determining a relative position between the rails and the reference point comprises determining a tilt angle between the imaging system and the reference point based on the at least one image.

18. A method according to claim 14, wherein capturing at least one image comprises capturing images of the reference point at different points in time.

19. A method according to claim 14, further comprising changing the position of the imaging system to capture multiple perspectives of the reference point.

20. A method according to claim 14, wherein capturing at least one image comprises capturing a single composite image having multiple perspectives of the reference point at the same time.
